(19) United States
(12) Patent Application Publication
(10) Pub. No.: US 2012/0057565 A1
(43) Pub. Date: Mar. 8, 2012

(54) DLS-ASSISTED WIRED TO WIRELESS HANDOVER

(75) Inventor: Mahalingam Mani, Cupertino, CA (US)

(73) Assignee: AVAYA INC., Basking Ridge, NJ (US)

(21) Appl. No.: 12/875,281

(22) Filed: Sep. 3, 2010

(51) Int. Cl. H04W 36/00

(52) U.S. Cl. 370/331; 370/352

(57) ABSTRACT

Solutions are proposed to enable a seamless handover/handback of a communication between a docked state and an undocked state. The transfer is effected by performing a transfer between a docked persona of a user and an undocked persona of that same user. By utilizing certain SIP transfer mechanisms or H.323 bridged-appearances, in-progress call sessions and media can be sustained during handover and/or handback.

### FIELD OF THE DISCLOSURE

The present disclosure is generally directed toward communications and more specifically preserving communications during wired/wireless handoffs of a communication device.

### BACKGROUND

With a device that can either be a desktop device or a mobile device, there is a problem with regard to handback at the instant of docking or handover at the instant of undocking. Specifically during either handover or handback while a communication session is in progress, there is the potential that packets of information can be lost or the communication session as a whole can be lost. This makes communications extremely frustrating and minimizes the value of having a device that can either be a desktop device or a mobile device.

Solutions have been proposed which enable a wireless phone to handoff a call to a wired phone. However, the handoff occurs between two different communication devices. As one example, U.S. Pat. No. 7,400,886 utilizes a mobility server to coordinate a transfer of a communication session from a wireless phone to a wired phone. Not only is the solution in the '886 patent undesirable because it introduces an additional piece of hardware (the mobility server) to facilitate the transfer, but it also is limited to situations where two different devices are used for a wireless and wired connection to the communication network. Transferring a communication session from one communication device to another different communication device is substantially different from preserving a communication session on a single communication device while it transitions from a wireless device to a wired device.

What is desired is the ability to facilitate a seamless handover/handback of communications sessions independent of media (e.g., voice, video, text, and other similar media sessions) between wired and wireless triggered by docking/undocking of a dual-purposed communication device.

### SUMMARY

It is with respect to the above issues and other problems that the embodiments presented herein were contemplated. This disclosure proposes, among other things, the ability to maintain a communication session (e.g., signaling and media traffic of a voice, video, text, and/or multimedia session) while a communication device transitions from a state where it is being utilized as a wired device to a state where it is being utilized as a wireless device. In some embodiments, multiple links are established with a single communication device and those links are selectively used depending upon the state in which the communication device is acting (i.e., wired or wireless state).

The seamlessness of the transfer can be achieved by establishing alternative communication channels with a single communication device. When that device is detected as transitioning from one state to another state, an in-progress communication session can be maintained by tunneling communications traffic from the originally active communication channel to an alternative channel until the device is registered for communications on the alternative channel. Once the device has registered for communications on the alternative channel, the tunneling of communications traffic can be discontinued and all subsequent communications traffic can be routed directly over the alternative channel, at least until another state change of the device is detected.

In some embodiments, detection of a state transition (e.g., detection that the communication device has transitioned from a wired state to a wireless state or vice versa) can be accomplished with one or more physical sensors, switches, buttons, or other indicia that a communication device has been physically removed from a docking station. As one example, a physical switch or button may be depressed when a communication device is in a wired state and the same switch or button may be released (i.e., open) when a communication device is in a wireless state. Other technologies which may be utilized to detect whether a communication device is in a wired or wireless state include, without limitation, proximity detection technologies, Infrared detection technologies, physical switches, and the like.

In some embodiments, when a communication device is in a wired state, the communication device may be receiving power from an external power source (e.g., an AC power outlet, an AC/DC converter, or any other power source not wholly contained within a hand-held portion of the communication device). On the other hand, when the communication device is in a wireless state, the communication device may not receive power from an external power source. Detection of the fact that power is not being provided to the communication device from an external source may indicate that the communication device is in the wireless state. Conversely, detection of the fact that power is being provided to the communication device from an external source may indicate that the communication device is in the wired state.

In some embodiments, an in-progress communication session is preserved without dropping media or signaling frames during either the docking or undocking of a dual-purposed communication device. Two or more different approaches may be utilized to achieve this desired objective.

One approach is used when there is no Wireless Local Area Network (WLAN)-enabled computing device coupled with the dual-purposed communication device. In this situation, WLAN connectivity and wired connectivity are enabled concurrently for a dual-purposed communication device when it is in a docked state. While docked, the communication session traffic travels over the wired connection. While undocked, the communication session traffic travels over the wireless connection. During the transition from a docked state to an undocked state or vice versa, communication traffic is tunneled from one communication channel to the other over a network backend.

Another approach is used when the dual-purposed communication device is coupled with a WLAN-enabled computing device. In this situation, a Direct Link Service (DLS) channel is established between the computing device and the dual-purposed communication device. While docked, the communication session traffic travels over the wired connection. While undocked, the communication session traffic travels over a wireless connection. During the transition from a docked state to an undocked state or vice versa, communication traffic is tunneled to the dual-purposed communication device via the DLS channel. In some embodiments, the DLS channel may be established before the dual-purposed communication device changes from one state to another state. In some embodiments, the DLS channel may be established in response to detecting that the dual-purposed communication device has changed from one state to another state.

In some embodiments a handover method is provided that generally comprises:

determining that a first communication device is transitioning from a wired state to a wireless state;

during the transition, tunneling communication packets transmitted to or from the first communication device via a communication channel established for the wired state;

determining that the first communication device has completed its transition from the wired state to the wireless state; and

after the first communication device has been determined to have completed its transition from the wired state to the wireless state, routing communication packets transmitted to or from the first communication device via a wireless communication channel established for the wireless state and discontinuing tunneling of communication packets transmitted to or from the first communication device via the communication channel established for the wired state.

In some embodiments, a handback method is provided that generally comprises:

determining that a first communication device is transitioning from a wireless state to a wired state;

during the transition, tunneling communication packets transmitted to or from the first communication device via a communication channel established for the wireless state;

determining that the first communication device has completed its transition from the wireless state to the wired state; and

after the first communication device has been determined to have completed its transition from the wireless state to the wired state, routing communication packets transmitted to or from the first communication device via a wired communication channel established for the wired state and discontinuing tunneling of communication packets transmitted to or from the first communication device via the communication channel established for the wireless state.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of a communication system in a first configuration in accordance with embodiments of the present disclosure;

FIG. 2 is a block diagram of a communication system in a second configuration in accordance with embodiments of the present disclosure;

FIG. 3 is a block diagram of a communication system in a third configuration in accordance with embodiments of the present disclosure;

FIG. 4 is a flow diagram depicting a first exemplary docked-to-undocked handover process in accordance with embodiments of the present disclosure;

FIG. 5 is a flow diagram depicting a first exemplary undocked-to-docked handback process in accordance with embodiments of the present disclosure;

FIG. 6 is a block diagram of a communication system in a fourth configuration in accordance with embodiments of the present disclosure;

FIG. 7 is a block diagram of a communication system in a fifth configuration in accordance with embodiments of the present disclosure;

FIG. 8 is a flow diagram depicting a second exemplary docked-to-undocked handover process in accordance with embodiments of the present disclosure; and

FIG. 9 is a flow diagram depicting a second exemplary undocked-to-docked handback process in accordance with embodiments of the present invention.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

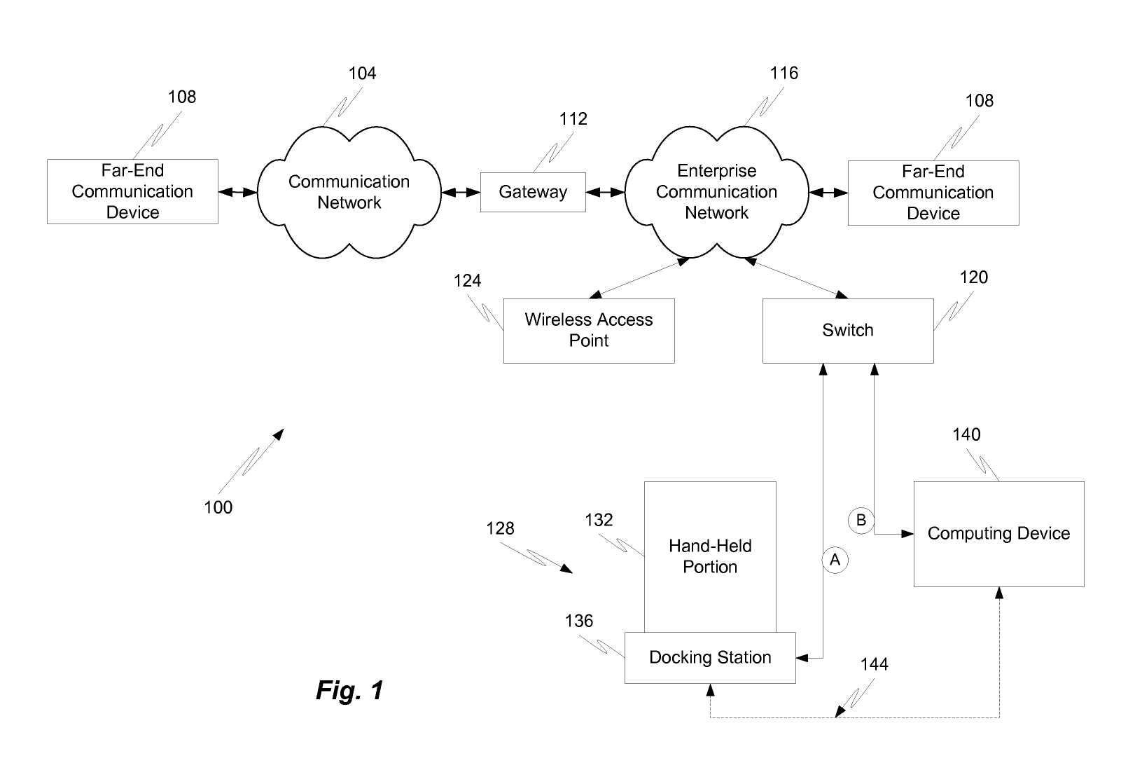

FIG. 1 shows an illustrative embodiment of a distributed communication system 100 in a first configuration in accordance with at least some embodiments of the present disclosure. The communication system 100 comprises a communication network 104 connecting one or more far-end communication devices 108 to an enterprise communication network 116, which may be owned and operated by an enterprise administering both the enterprise communication network 116 and all devices connected to the enterprise communication network 116.

In some embodiments, the enterprise communication network 116 is separated from the communication network 104 by a gateway 112, which acts as a physical and logical barrier between the enterprise communication network 116 and the communication network 104. The gateway 112, while not necessary, is usually desirable to control security of the enterprise communication network 116.

In particular, the communication network 104 may correspond to an un-trusted communication network that does not have any unitary set of rules or protocols for maintaining the safety and security of information shared across the communication network 104. The enterprise communication network 116, on the other hand, may be administered by a single enterprise or business and may, therefore, be administered with a strict set of security rules. As such, the gateway 112 may comprise functionality to (1) filter out un-trusted or unwanted communications from the communication network 104 and (2) translate communications from the communication network 104 such that the communications can be handled according to the protocols of the enterprise communication network. 116.

In a very simple example, the communication network 104 may correspond to a circuit-switched communication network and the enterprise communication network 116 may correspond to a packet-switched communication network. In a more specific example, the enterprise communication network 116 may correspond to a Session Initiation Protocol (SIP)-based or H.323-based network.

In accordance with at least some embodiments of the present disclosure, one or both of the communication networks 104, 116 may comprise any type of known communication medium or collection of communication media and may use any type of protocols to transport messages between endpoints. The communication networks 104, 116 may include wired and/or wireless communication technologies. The Internet is an example of the communication network 104 that constitutes and Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a SIP network, a cellular network, and any other type of packet-switched or circuit-switched network known in the art. Examples of the enterprise communication network 116 includes, without limitation, a LAN, a WAN, a SIP network, an H.323 network, or combinations thereof. In addition, it can be appreciated that the communication networks 104, 116 need not be limited to any one network type, and instead may be comprised of a number of different networks and/or network types. Moreover, the communication networks 104, 116 may comprise a number of different communication media such as coaxial cable, copper cable/wire, fiber-optic cable, antennas for transmitting/receiving wireless messages, and combinations thereof.

In accordance with at least some embodiments, the communication network(s) 104, 116 enable communications between a first communication device 128 and one or more far-end communication devices 108. One or more users may utilize the first communication device 128 to engage in a communication session with one or more users on a far-end communication device 108. As can be seen in FIG. 1, a far-end communication device 108 may be connected to the enterprise communication network 116 or it may be connected to the un-trusted communication network 104.

In accordance with at least some embodiments of the present disclosure, the communication devices 108, 128 may comprise any type of known communication equipment or collection of communication equipment. Examples of a suitable communication devices 108, 128 include, but are not limited to, a personal computer, laptop, Personal Digital Assistant (PDA), cellular phone, smart phone, telephone, or combinations thereof. In general each communication device 108, 128 may be adapted to support video, audio, text, and/or data communications with other communication devices 108, 128. The type of medium or media used by the communication device 108, 128 to communicate with other communication devices 108, 128 may depend upon the communication applications available on the communication devices 108, 128.

The first communication device 128 may engage in one, two, three, or more communication sessions with one or several far-end communication devices 108 at substantially the same time. Exemplary types of communication sessions which may be supported by the first communication device 128 include, without limitation, voice communication sessions, video communication sessions, text communication sessions, multi-media communication sessions, and any other real-time, near-real-time, or non-real-time communication sessions. In embodiments where real-time communication sessions are established with the first communication device 128, media packets and session control packets may be transmitted to/from the first communication device 128 across the communication network(s) 104, 116 to the far-end communication device 108. The media packets transmitted during a communication session generally contain the media payload of the communication session (e.g., voice, video, and text data). The session control packets may include commands for controlling the communication session, commands for controlling the path across which the media packets are transmitted between the far-end communication device 108 and first communication device 128, and the like.

The first communication device 128 may be connected to the enterprise communication network 116 via a switch 120 or similar processing device. The switch 120 acts as a mechanism for controlling the flow of communication packets (i.e., media packets and/or session control packets) to/from the first communication device 128. In some embodiments, the connection between the first communication device 128 and the switch 120 is a wired connection, although a high-speed wireless connection (e.g., Bluetooth) may be utilized to connect the switch 120 and first communication device 128. Generally speaking, the switch 120 enables the first communication device 128 to operate in a wired state.

A wireless access point 124 may also be provided to facilitate wireless communications and enable the first communication device 128 to operate in a wireless state. The wireless access point 124 may be any type of wireless router. In some embodiments, the wireless access point 124 may include functionality of a modem, but such functionality is not required. The wireless access point 124 may utilize any known technology for facilitating wireless communications. As one example, the wireless access point 124 may utilize any 802.11 standard. As another example, the wireless access point 124 may utilize Bluetooth.

In some embodiments, the wireless access point 124 may correspond to a cellular tower that enables the first communication device 128 to engage in cellular communications. In such an embodiment, however, the wireless access point 124 is more likely to be connected to the communication network 104 rather than the enterprise communication network 116 as it is unlikely that an enterprise is administering a private cellular communications network. Of course, it remains a possibility that a cellular-based wireless access point 124 may be connected to the enterprise communication network 116.

In the configuration depicted in FIG. 1, the first communication device 128 may be coupled with a computing device 140 that is also in communication with the switch 120. Of course, the computing device 140 may alternatively, or additionally, be connected to the enterprise communication network 116 via the wireless access point 124. Examples of a suitable computing device 140 include, without limitation, a personal computer, a netbook, a laptop, a PDA, a server, or the like.

Data exchanges between the first communication device 128 and the computing device 140 may travel through the switch 120 or may travel through a wired or wireless direct link (not depicted) between the first communication device 128 and computing device 140.

In some embodiments, the first communication device 128 can be controlled by the computing device 140 by an application running on the computing device 140. The first communication device 128 may also be configured to retrieve data from the computing device 140 to facilitate communications and communication sessions with far-end communication devices 108. As one example, the first communication device 128 may be configured to retrieve contact information from an enterprise directory by utilizing database lookup tools of the computing device 140. The computing device 140 may also be utilized to perform processing tasks on behalf of the first communication device 128. Thus, the first communication device 128 may operate as an extension of the computing device 140 and vice versa. This may hold true while the communication device 128 is operating in either a wired or wireless state.

In some embodiments, the first communication device 128 may be configured to operate in both a wired and a wireless state. The path across which media and/or session control packets are transmitted during a communication session may depend upon whether the first communication device 128 is operating in a wired state, a wireless state, or is transitioning between a wired and wireless state (i.e., is in a transitioning state). Preferably, packets transmitted during a communication session are neither lost nor discarded when the communication device 128 is transitioning from a wired to wireless state, or vice versa. More preferably, delays in the transmission of communication packets should be minimized when the first communication device 128 is transitioning between a wired and wireless state.

In the configuration depicted in FIG. 1, an alternative communication channel 144 is established between the first communication device 128 and the computing device 140. The alternative communication channel 144 is utilized to ensure that communication packets are not lost or delayed during a communication session, regardless of whether the first communication device 128 is operating in a wired state, a wireless state, or a transitioning state. In some embodiments, the alternative communication channel 144 comprises a DLS channel which enables communication packets to be transmitted directly between the first communication device 128 and the computing device 140 while the first communication device 128 is in a transitioning state. The utilization of the alternative communication channel 144 enables a communication session to be maintained without lost packets or delay while the first communication device 128 is in a transitioning state.

The first communication device 128 is unique in that it is capable of operating in both a wired and wireless state. In the wired state, a hand-held portion 132 of the first communication device 128 is docked or mated with a docking station 136. In this position, the first communication device 128 is considered to be in a wired state. Alternatively, the first communication device 128 may be considered to be in a docked state.

The hand-held portion 132 of the first communication device 128 is removable from the docking station 136. When the hand-held portion 132 is separated from the docking station 136, the first device 128 may be considered to be in a wireless state. Alternatively, the first communication device may be considered to be in an undocked state.

There is a short transition period that occurs when the first communication device 128 is transitioning from a wired state to a wireless state or from a wireless state to a wired state. The transition period arises at two different times. First, a transition period occurs after the hand-held portion 132 has been removed from the docking station 136 and before the hand-held portion 132 of the first communication device 128 has established a wireless communication channel with the wireless access point 124. Second, a transition period occurs after the hand-held portion 132 has been placed in the docking station 136 and before a communication channel has been established between the first communication device 128 and the switch 120. It is during these transition periods where the alternative communication channel 144 is used to maintain a communication session that is in progress during the transition period.

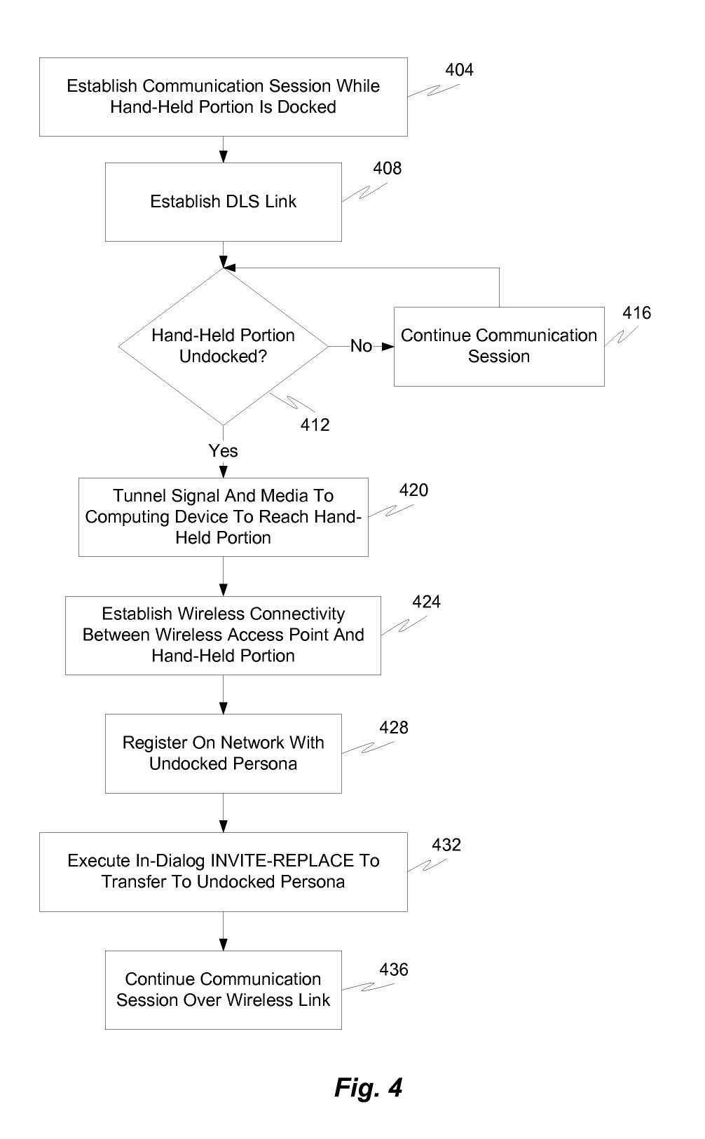

With reference now to FIGS. 1-5, additional details related to maintaining a communication session on the first communication device 128 during both of the above-identified transition periods will be described. Initially, with reference to FIGS. 1-3 and 4, the operation of the communication system 100 and the first communication device 128 during the transition from a wired state to a wireless state (handover) will be described in accordance with at least some embodiments of the present disclosure. The method begins as depicted in FIG. 1, where the hand-held portion 132 of the first communication device 128 is docked in the docking station 136 of the first communication device 128. In this configuration, the first communication device 128 is considered to be in a wired state. When a communication session is established in this configuration between the first communication device 128 and a far-end communication device 108, communication packets traverse path A between the switch 120 and first communication device 128 (step 404). Simultaneous with the establishment of a communication session or before a communication session is established, a DLS link or similar alternative channel 144 is established between the first communication device 128 and computing device 140 (step 408). In some embodiments, wireless LAN establishment protocols, such as 802.11x, are used to set up the DLS link between the first communication device 128 and computing device 140. Even though the alternative channel 144 is established, communication packets exchanged during the communication session traverse path A.

The method continues by determining whether the hand-held portion 132 has been undocked from the docking station 136 (step 412). In this step, one or both of the hand-held portion 132 and docking station 136 may analyze the physical connection between the hand-held portion 132 and docking station 136 to determine whether the hand-held portion 132 has been undocked. Physical switches, buttons, proximity detectors, and the like may be utilized to analyze the physical relationship of the hand-held portion 132 and docking station 136. In some embodiments, the analysis of whether the hand-held portion 132 is docked can be made by determining whether an external power source (i.e., a source of power other than a battery of the hand-held portion 132) is being utilized to provide power to the hand-held portion 132 of the first communication device 128. As noted above, this determination can be made by the hand-held portion 132, the docking station 136, or both.

In an exemplary implementation, a physical switch or button is located in the area where the hand-held portion 132 interfaces with the docking station 136. When that switch or button is depressed, the hand-held portion 132 is determined to be docked and the first communication device 128 is considered to be in a wired state. If the switch or button is not depressed, then the hand-held portion 132 is determined to be in a wireless state.

If the query of step 412 is answered negatively, then the first communication device 128 is determined to still be in a wired state and the communication session is continued as originally established (step 416). More specifically, communication packets continue to traverse path A.

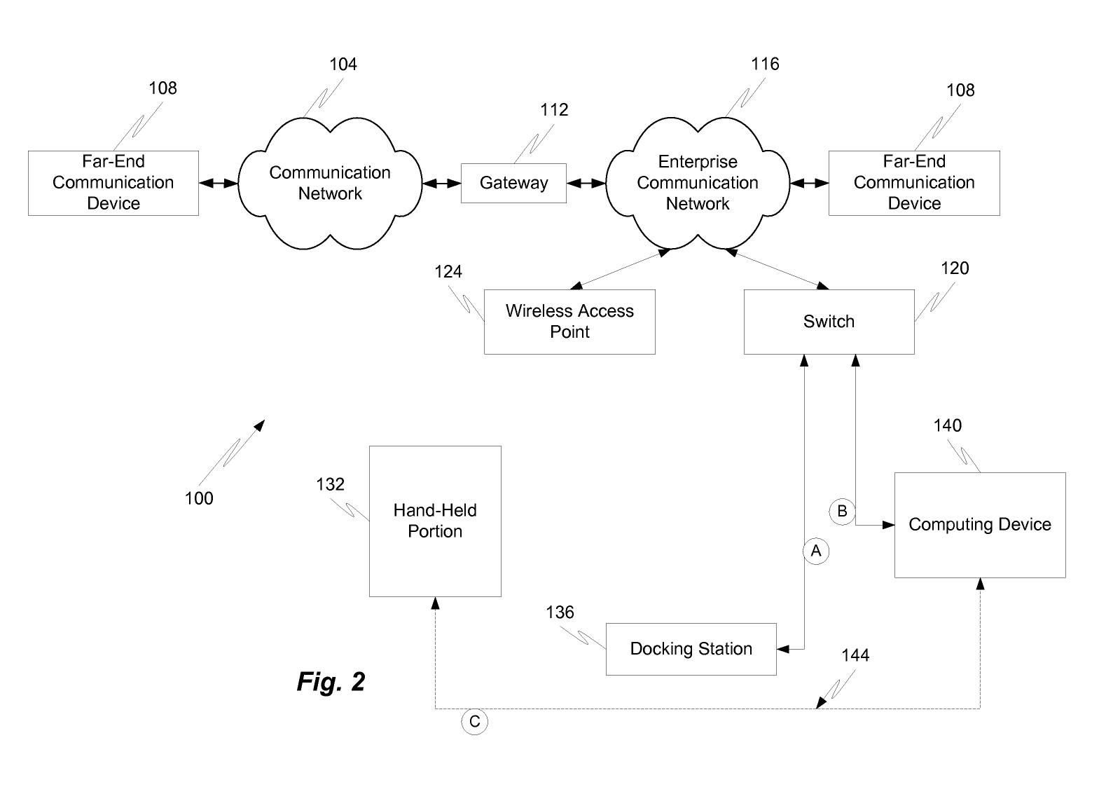

If, however, the query of step 412 is answered affirmatively, then the first communication device 128 is transitioning from a wired state to a wireless state. Immediately upon sensing this transition, the docking station 136 of the first communication device 128 begins tunneling communication packets (media and session control) to the computing device 140, which in-turn tunnels the communication packets to the hand-held portion 132 (step 420). This particular system configuration during the system 100 transition is depicted in FIG. 2. At this point, communication packets directed toward the first communication device 128 are received at the docking station 136, which re-routes the communication packets back to the switch 120 via path A, to be tunneled to the computing device 140 via path B. Computing device 140, in turn, tunnels the received communication packets to the hand-held portion 132 of the first communication device 128 via the alternative channel 144 (path C).

Likewise, communication packets transmitted by the first communication device 128 are first transmitted by the hand-held portion 132 to the computing device 140 via the alternative channel 144 (path C). The computing device 140 then tunnels the packets to the docking station 136 of the first communication device 128 via path B and then path A. Thereafter, the communication packets are transmitted by the docking station 136 back over path A toward the far-end communication device(s) 108.

During this transition period, a docked persona is used by the first communication device 128 to enable communications between the user of the first communication device 128 and other users at far-end communication devices 108. This docked persona is a communication profile of a user that is utilizing the first communication device 128. Communication packets are routed across the enterprise communication network 116 according to the docked persona, at least until a transition to an undocked persona has been achieved. Accordingly, call features

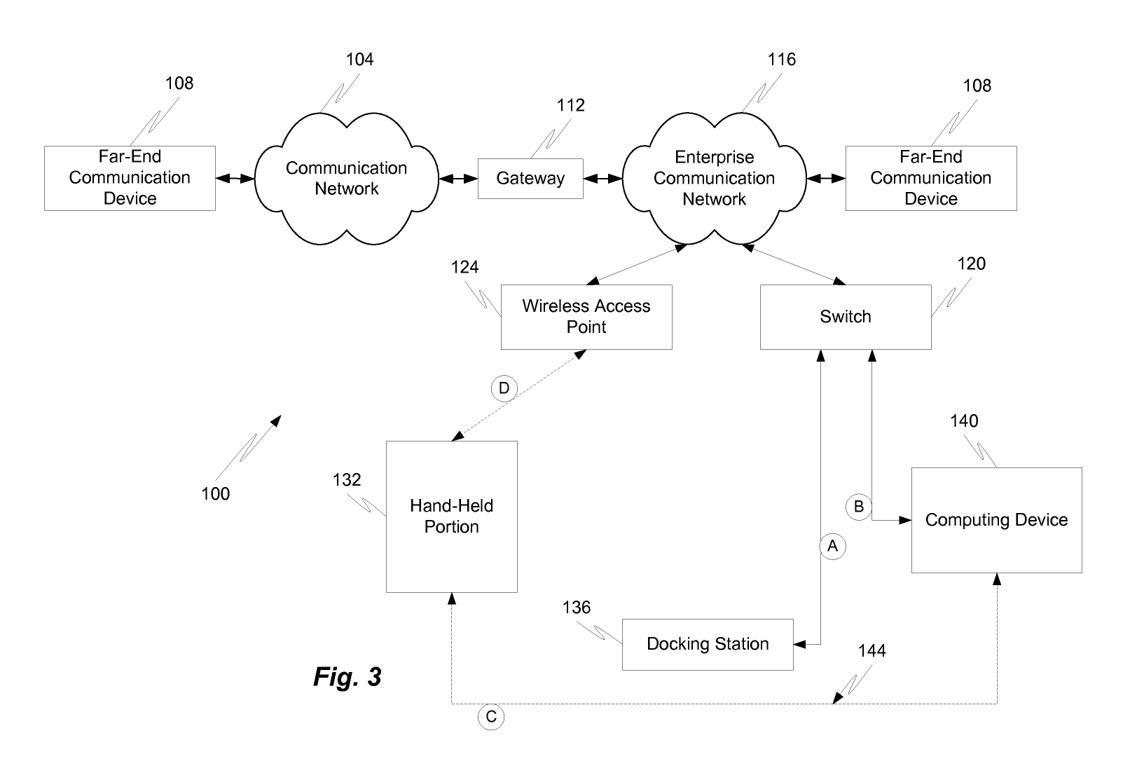

Simultaneous with, before, or after step 420, a wireless connection (path D) is established between the hand-held portion 132 of the first communication device 128 and the wireless access point 124 (step 424). The point at which the hand-held portion 132 of the first communication device 128 has established a wireless connection with the wireless access point 124 is depicted in FIG. 3. The wireless connection established between the first communication device 128 and the wireless access point 124 may comprise any type of known wireless connection such as a WLAN connection, a cellular connection, a Bluetooth connection, or the like.

At this point, even though there is a wireless connection available to the first communication device 128, the first communication device 128 is still in a transitioning state because an existing communication session is still utilizing the docked persona of the user of the first communication device 128. Therefore, the method continues by registering the first communication device 128 on the enterprise communication network 116 with an undocked persona.

The handover from a wired state to a wireless state is achieved by performing a transfer between the docked persona of the user of the first communication device 128 to an undocked persona of the user of the first communication device 128. The undocked persona is registered for communications over a wireless connection whereas the docked persona is registered for communication over a wired connection. Both personas, however, refer to the same Address of Record (AoR) (i.e., are used by the same user for call routing within the enterprise communication network 116 and to obtain desired communication session functionality in the enterprise communication network 116). Since both the docked and undocked persona refer to the same user, it may also be possible to utilize an extension that maps the same Globally Routable UserAgent URI (GRUU) to both the docked and undocked personas. Such a mapping and utilization of GRUU would maintain the continuity of reference for the rest of the world to the first communication device 128, regardless of whether it is in a wired or wireless state (i.e., docked or undocked). In other words, due to the nature of the proposed solution and due to the nature of GRUU, it is possible during the handover and handback process to provide a SIP OPTION tag or SIP Feature tag (which may be vendor specified) to signal the registrar in the enterprise communication network 116 that the GRUU outgoing device in handover be re-bound to the GRUU of an incoming device. This preserves the ability of far-end communication devices 108 to continue to reach the first communication device 128.

A similar mechanism may be utilized if the first communication device 128 is H.323-enabled. Rather than utilizing a special global-addressing scheme, the use of < > command and a bridged-appearance of the first communication device 128 may achieve the same effects as if a GRUU were used.

Accordingly, the first communication device 128 is generally considered to still be in the transitioning state until it has registered with the enterprise communication network 116 with its undocked persona. Until that time (e.g., as long as the docked persona is still being used to effect communications for the first communication device 128), the first communication device 128 is still in the transitioning state. This means that tunneling of communication packets from the docking station 136 to the hand-held portion 132 of the first communication device 128 via the alternative channel 144 (path C) is utilized.

Once the first communication device 128 has registered on the enterprise communication network 116 with the undocked persona (step 428), the appropriate components in the enterprise communication network 116 execute an in-dialog transfer of the in-progress communication session from the docked persona to the undocked persona (step 432). In a SIP implementation, an INVITE-REPLACE command may be utilized to transfer the communication session to the undocked persona. In an H.323 implementation, a dialog-transfer feature offered by the enterprise communication network 116 may be utilized to transfer the dialog of the in-progress communication session to the undocked persona.

Once the transfer has been completed, the method proceeds with the communication session continuing over the wireless link (step 436). More specifically, communication packets of the communication session now traverse path D rather than the alternative channel 144. At this point the first communication device 128 has successfully transitioned from the wired state to a wireless state and is no longer in the transitioning state.

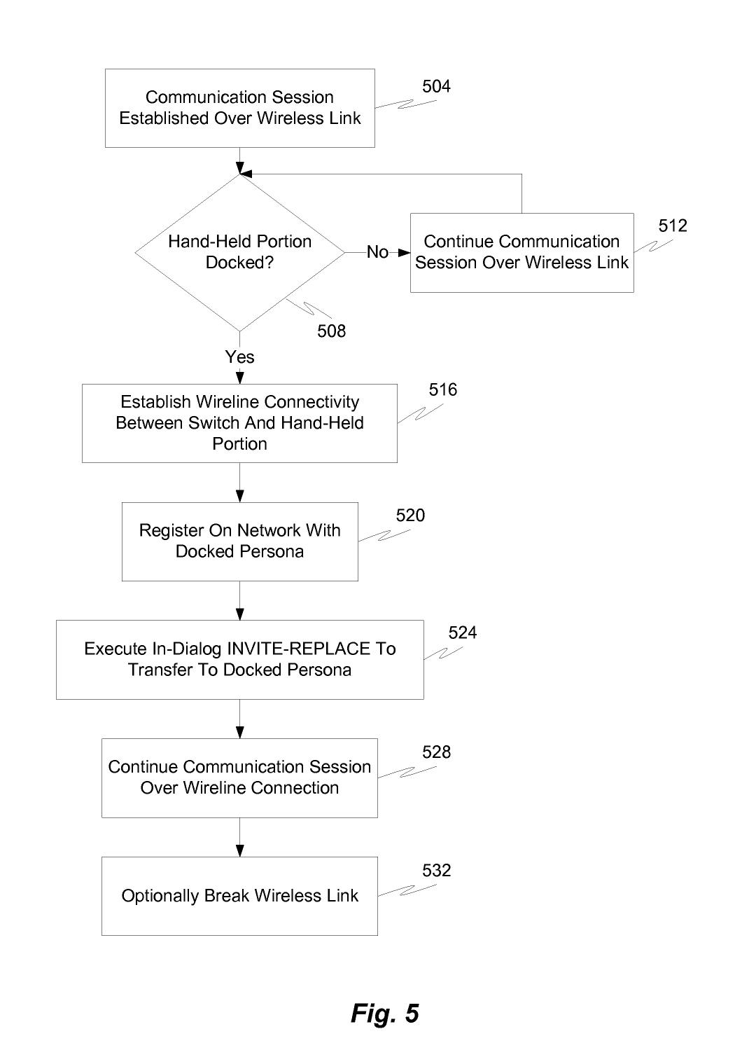

With reference now to FIG. 5, an exemplary handback method whereby the first communication device 128 transitions from a wireless state to a wired state while facilitating an in-progress communication session will be described. The physical configuration of the communication system 100 during the handback process is essentially the reverse of the configuration of the communication system 100 during the handover process. However, the transitioning period begins when the hand-held portion 132 is physically docked with the docking station 136 and ends when the communication session has been successfully transferred from an undocked persona to a docked persona.

The method begins when the first communication device 128 establishes a communication session over a wireless link (path D) with a far-end communication device 108 (step 504). In this step, the first communication device 128 is utilizing an undocked persona to facilitate the communication session. In some embodiments, step 504 may be a continuation from step 436 (i.e., the communication session may be continuing after it was originally established over a wired link) or it may be a new communication session that was originally established over the wireless link.

The method continues by determining whether the hand-held portion 132 of the first communication device 128 has been mated with the docking station 136 (step 508). The tools used in this step may be similar or identical to the tools used in step 412, however the analysis may be reversed.

If the hand-held portion 132 is determined to still be undocked, then the communication session continues over the wireless link (step 512). Furthermore, the first communication device 128 remains in a wireless state and communication packets transmitted during the communication session still traverse path D.

If the hand-held portion 132 is determined to now be docked with the docking portion 136, then the method continues with the first communication device 128 establishing wireline connectivity between itself and the switch 120 (step 516). In particular, path A is established as a communication channel between the hand-held portion 132 and the switch 120 via the docking station 136.

Even after the wireline connectivity has been established it is necessary to complete the transition from the wireless state to the wired state. Completion of this task generally depends upon transferring the in-progress communication session from the undocked persona to a docked persona. Accordingly, after the wireline connectivity has been established between the first communication device 128 and the enterprise communication network 116, the method continues with the first communication device 128 registering on the enterprise communication network 116 with its docked persona (step 520).

Thereafter, the in-progress communication session is transferred from the undocked persona to the docked persona (step 524). The mechanisms used to complete this transfer may be similar or identical to the mechanisms used to complete the transfer of step 432, but the transfer process is performed in reverse. Until the first communication device 128 has successfully transferred the in-progress communication session from the undocked persona to the docked persona, the first communication device 128 is in a transitioning state and communication packets still traverse path D.

Once the transition has been completed, however, the method continues by continuing the communication session over the wireline connection and communication packets then traverse path A (step 528). Thereafter, an optional step of breaking the wireless link between the first communication device 128 and the wireless access point 124 may be performed (step 532). This step may not be necessary or desirable if the first communication device 128 is likely to transition back to the wireless state. However, it may be desirable to tear down the connection to preserve resources of the wireless access point 124 (e.g., to free up wireless bandwidth for other communication devices).

The value of providing an alternative channel 144, such as a DLS link, is that an in-progress communication session can continue while the first communication device 128 transitions from a wired state to a wireless state. The dialog of the communication session can continue until the communication session is parked for REPLACE action and the communication session proceeds unhampered. Without the alternative channel 144, the media of the communication session may stutter until the first communication device 128 has registered with the undocked persona and the communication session has been successfully replaced the docked persona with the undocked persona.

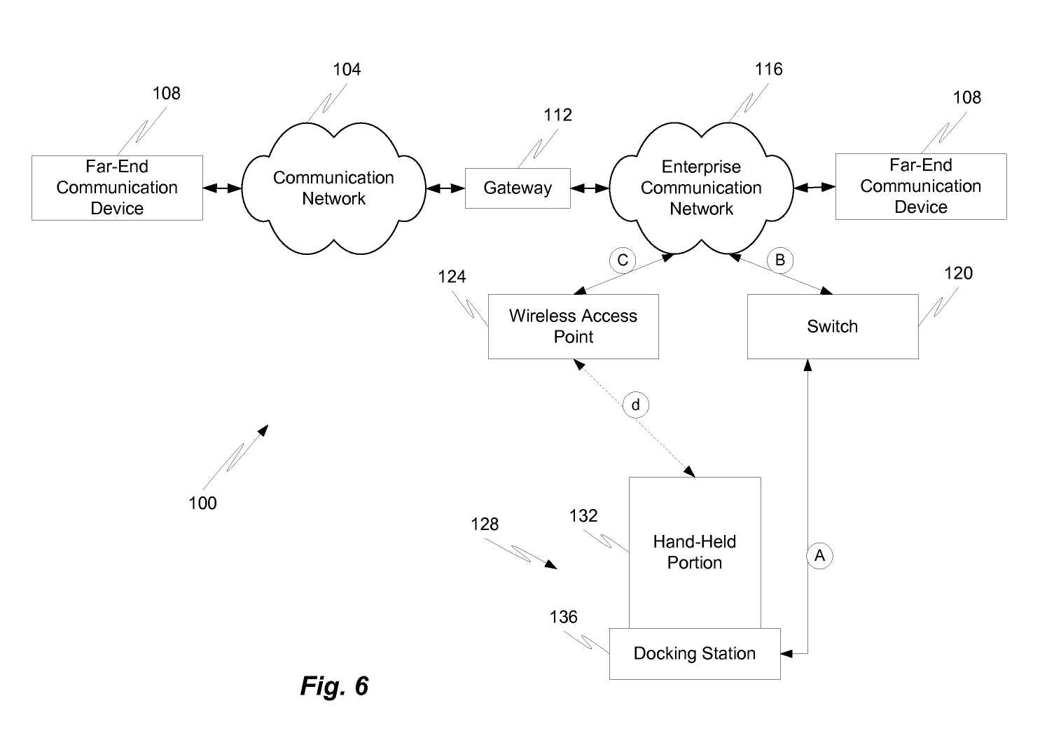

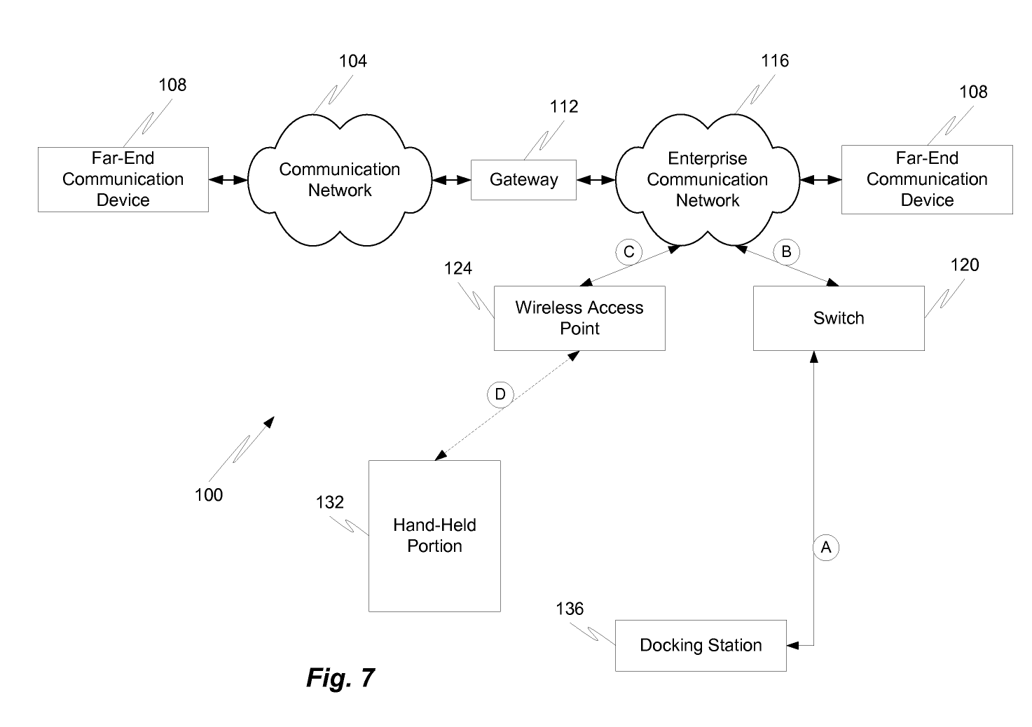

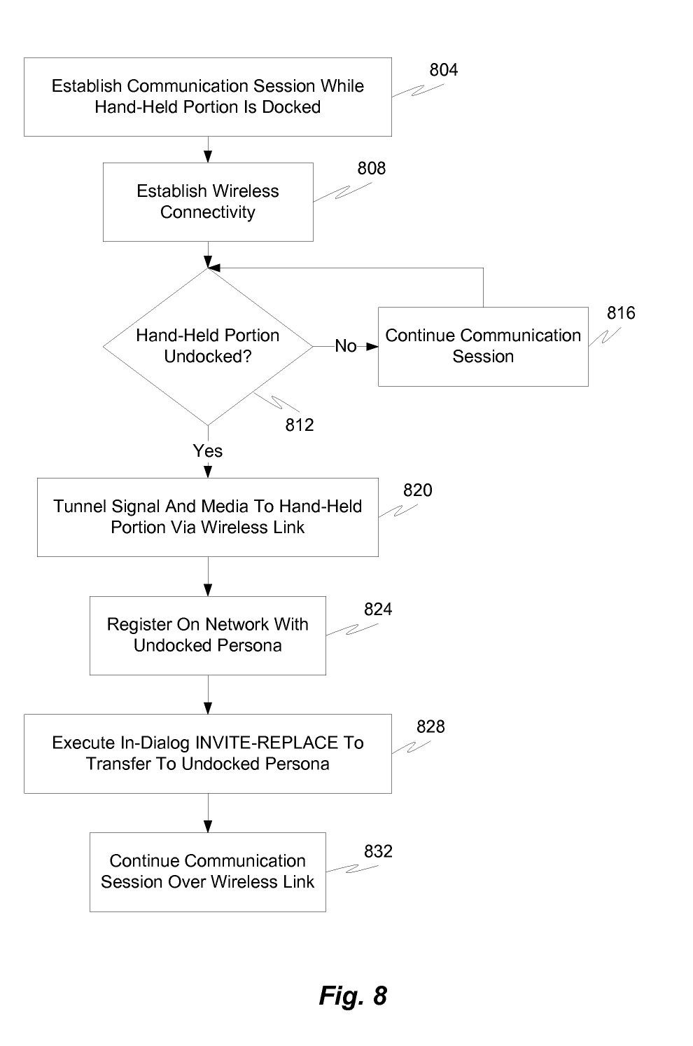

There may be instances where the first communication device 128 is not coupled with a computing device 140 and the establishment of an alternative channel 144 is not possible or desirable. Such a system 100 configuration is depicted in FIGS. 6-7. With reference now to FIGS. 6-9, the handover and handback processes utilized in such a system 100 configuration will be discussed in accordance with at least some embodiments of the present disclosure.

Initially, with reference to FIGS. 6-8, the operation of the communication system 100 and the first communication device 128 during the transition from a wired state to a wireless state (handover) will be described in accordance with at least some embodiments of the present disclosure. The method begins as depicted in FIG. 6, where the hand-held portion 132 of the first communication device 128 is docked in the docking station 136 of the first communication device 128. In this configuration, the first communication device 128 is considered to be in a wired state. When a communication session is established in this configuration between the first communication device 128 and a far-end communication device 108, communication packets traverse path A between the switch 120 and first communication device 128 (step 804). This step may be similar or identical to step 404. Before, simultaneous with, or after step 804, the first communication device 128 may also establish wireless connectivity with the wireless access point (step 808). While wireless connectivity is available it is generally not used to carry communication packets if the first communication device 128 is in a wired state. In other words, as long as the first communication device 128 is in a wired state, path d may exist but is generally not used to carry any communication packets. Rather, communication packets transmitted between the first communication device 128 and far-end communication devices 108 traverse path A.

The method proceeds by determining whether the hand-held portion 132 has been undocked from the docking station 136 (step 812). This step may be similar or identical to step 412 and is generally based upon the physical relationship of the hand-held portion 132 and docking station 136.

If the hand-held portion 132 is determined to still be docked in the docking station 136, the communication session continues as normal and communication packets continue to traverse path A (step 816).

If the hand-held portion 132 is determined to be undocked from the docking station 136, then the first communication device 128 begins transitioning from the wired state to a wireless state. Immediately after it has been determined that the hand-held portion 132 is undocked from the docking station 136 and during the transition to the wireless state, communication packets are tunneled from the docking station 136 over the backbone of the enterprise communication network 116 to the hand-held portion 132 and vice versa (step 820). Thus, during the transitioning state depicted in FIG. 7, communication packets received at the first communication device 128 from a far-end communication device 108 traverse path A and are received at the docking station 136. The communication packets then re-traverse path A back to the switch 120 and are routed over paths B and C until they reach the wireless access point 124. The wireless access point 124 then tunnels the communication packets to the hand-held portion 132 via path D.

Likewise, communication packets transmitted from the first communication device 128 to a far-end device 108 first traverse path D, then path C, then path B, then path A to the docking station 136. The docking station 136 then transmits the communication packets back across path A toward the far-end communication device 108. Packet delay is greatly reduced since the wireless channel between the wireless access point 124 and first communication device 128 was likely established before the first communication device 128 became undocked.

The method continues with the first communication device 128 registering on the enterprise communication network 116 with an undocked persona (step 824). This step may be similar or identical to step 428 and may utilize GRUU mapping functions or bridged line appearance to make the transition from an docked persona to an undocked persona transparent to the outside world.

Once the first communication device 128 has registered with the undocked persona, the appropriate components of the enterprise communication network 116, including the first communication device 128, execute an in-dialog transfer of the in-progress communication session from the docked persona to the undocked persona (step 828). This step may be similar or identical to step 432.

Once the transfer has been completed, the method proceeds with the communication session continuing over the wireless link (step 832). More specifically, communication packets to/from the first communication device 128 only have to traverse path D rather than being tunneled between the docking station 136 and hand-held portion 132.

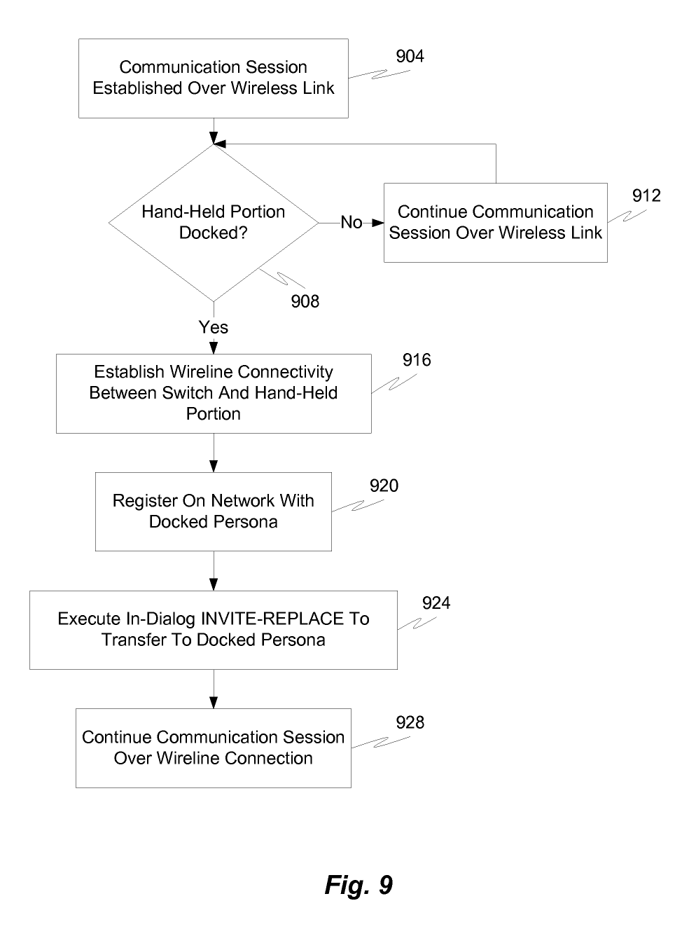

Referring now to FIG. 9, an exemplary handback process whereby the first communication device 128 transitions from a wireless state to a wired state while facilitating an in-progress communication session will be described. Most of the steps in FIG. 9 may be similar or identical to the steps performed in FIG. 5.

The method begins when the first communication device 128 establishes a communication session over a wireless link (path D) with a far-end communication device 108 (step 904). In this step, the first communication device 128 is utilizing an undocked persona to facilitate the communication session. In some embodiments, step 904 may be a continuation from step 832 (i.e., the communication session may be continuing after it was originally established over a wired link) or it may be a new communication session that was originally established over the wireless link.

The method continues by determining whether the hand-held portion 132 of the first communication device 128 has been mated with the docking station 136 (step 908). The tools used in this step may be similar or identical to the tools used in step 812, however the analysis may be reversed.

If the hand-held portion 132 is determined to still be undocked, then the communication session continues over the wireless link (step 912). Furthermore, the first communication device 128 remains in a wireless state and communication packets transmitted during the communication session still traverse path D.

If the hand-held portion 132 is determined to now be docked with the docking portion 136, then the method continues with the first communication device 128 establishing wireline connectivity between itself and the switch 120 (step 916). In particular, path A is established as a communication channel between the hand-held portion 132 and the switch 120 via the docking station 136.

Even after the wireline connectivity has been established it is necessary to complete the transition from the wireless state to the wired state. Completion of this task generally depends upon transferring the in-progress communication session from the undocked persona to a docked persona. Accordingly, after the wireline connectivity has been established between the first communication device 128 and the enterprise communication network 116, the method continues with the first communication device 128 registering on the enterprise communication network 116 with its docked persona (step 920).

Thereafter, the in-progress communication session is transferred from the undocked persona to the docked persona (step 924). The mechanisms used to complete this transfer may be similar or identical to the mechanisms used to complete the transfer of step 828, but the transfer process is performed in reverse. Until the first communication device 128 has successfully transferred the in-progress communication session from the undocked persona to the docked persona, the first communication device 128 is in a transitioning state and communication packets still traverse path D.

Once the transition has been completed, however, the method continues by continuing the communication session over the wireline connection and communication packets then traverse path A (step 928). The wireless connection (path d) between the first communication device 128 and the wireless access point 124 is maintained just incase the first communication device 128 needs to transition back to a wireless state.

Without the alternative channel 144, the media of a communication session may stutter until the registration and transfer operations have been completed. This particular problem is solved by using soft-intelligence in the hand-held portion 132 which synchronizes the switching from a docked to an undocked persona with the switching from one communication channel to another. Until the docked persona has been replaced with the undocked persona, tunneling procedures are utilized to ensure that communication packets are not lost.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
determining that a first communication device is transitioning from a wired state to a wireless state;
during the transition, tunneling communication packets transmitted to or from the first communication device via a communication channel established for the wired state;
determining that the first communication device has completed its transition from the wired state to the wireless state; and
after the first communication device has been determined to have completed its transition from the wired state to the wireless state, routing communication packets transmitted to or from the first communication device via a wireless communication channel established for the wireless state and discontinuing tunneling of communication packets transmitted to or from the first communication device via the communication channel established for the wired state.

2. The method of claim 1, wherein the first communication device is determined to be transitioning from a wired state to a wireless state by detecting a physical separation of a hand-held portion of the first communication device from a docking station of the first communication device.

3. The method of claim 2, wherein at least one of a physical button, physical switch, and proximity detector are used to detect the physical separation of the hand-held portion from the docking station.

4. The method of claim 2, wherein the first communication device begins transitioning from a wired state to a wireless state when the hand-held portion is physically separated from the docking station and wherein the first communication device completes its transition after a first persona used for communicating in the wired state has been replaced with a second persona used for communicating in the wireless state.

5. The method of claim 4, wherein the first persona comprises a docked persona, wherein the second persona comprises an undocked persona, and wherein the first and second personas are mapped to a common GRUU.

6. The method of claim 1, wherein during the transition, communication packets transmitted to or from the first communication device are routed over a DLS link established between the first communication device and a computing device.

7. The method of claim 1, wherein during the transition, communication packets transmitted to or from the first communication device are routed over a network backend.

8. A method, comprising:
determining that a first communication device is transitioning from a wireless state to a wired state;
during the transition, tunneling communication packets transmitted to or from the first communication device via a communication channel established for the wireless state;
determining that the first communication device has completed its transition from the wireless state to the wired state; and
after the first communication device has been determined to have completed its transition from the wireless state to the wired state, routing communication packets transmitted to or from the first communication device via a wired communication channel established for the wired state and discontinuing tunneling of communication packets transmitted to or from the first communication device via the communication channel established for the wireless state.

9. The method of claim 8, wherein the first communication device is determined to be transitioning from a wireless state to a wired state by detecting a physical docking of a hand-held portion of the first communication device to a docking station of the first communication device.

10. The method of claim 9, wherein the docking of the hand-held portion to the docking station is detected by determining that power is being provided to the hand-held portion by an external power source.

11. The method of claim 9, wherein the first communication device begins transitioning from a wireless state to a wired state when the hand-held portion is physically docked to the docking station and wherein the first communication device completes its transition after a first persona used for communicating in the wireless state has been replaced with a second persona used for communicating in the wired state.

12. The method of claim 11, wherein the first persona comprises an undocked persona and wherein the second persona comprises a docked persona.

13. The method of claim 12, wherein the undocked persona is replaced with the docked persona by utilizing an INVITE-REPLACE command.

14. The method of claim 12, wherein the undocked persona is replaced with the docked persona by utilizing a dialog-transfer feature.

15. A communication system, comprising:
a first communication device configured to engage in communication sessions with far-end communication devices in a wired, a wireless state, and transitions between the wired and wireless states, wherein a first communication channel is utilized by the first communication device in a wired state, wherein a second communication channel is utilized by the first communication device in a wireless state, and wherein during transitions between the wired and wireless state communication packets are tunneled to a hand-held portion of the first communication device over at least one of a network backend and an alternative communication channel established for transitions between the wired and wireless state.

16. The system of claim 15, wherein a transition from the wired state to the wireless state begins when the hand-held portion is physically separated from a docking station of the first communication device and wherein the transition from the wired state to the wireless state is completed after a first persona used for communicating in the wired state has been replaced with a second persona used for communicating in the wireless state.

17. The system of claim 16, wherein the first persona is replaced with the second persona by utilizing at least one of an INVITE-REPLACE command and a dialog-transfer feature.

18. The system of claim 15, wherein a transition from the wireless state to the wired state begins when the hand-held portion is physically docked with a docking station of the first communication device and wherein the transition from the wireless state to the wired state is completed after a first persona used for communicating in the wireless state has been replaced with a second persona used for communicating in the wired state.

19. The system of claim 18, wherein the first persona comprises a docked persona, wherein the second persona comprises an undocked persona, and wherein the first and second personas are mapped to a common GRUU.

20. The system of claim 15, wherein the alternative communication channel is used during transitions between the wired and wireless state and wherein the alternative communication channel comprises a DLS link.
